(19) United States
(12) Patent Application Publication
(10) Pub. No.: US 2006/0206373 A1
(43) Pub. Date: Sep. 14, 2006

(54) Establishing a timing threshold

(76) Inventors: Timothy P. Blair, Boise, ID (US); Burton H. Poppenga, Eagle, ID (US); Roger T. Baird, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/074,812

(22) Filed: Mar. 8, 2005

(51) Int. Cl. G06F 11/34

(52) U.S. Cl. 705/11

(57) ABSTRACT

A timing threshold is used for determining when to issue an alert indicating installation of a replacement part is overdue. To determine the time threshold, a replacement part is ordered according to a service alert for a device. The device is monitored to determine when the replacement part is installed. The timing threshold is then determined based at least in part on a time between when the replacement part was ordered and when the replacement part was installed.

Service providers for printers, copiers, multi-function peripherals, and other imaging devices are hired by their customers to provide and maintain those devices. The service provider is responsible for monitoring the imaging devices and ordering replacement parts for items such as toner and ink.

### DRAWINGS

FIG. 1 is a schematic diagram of an exemplary environment in which various embodiments of the present invention may be implemented.

FIGS. 2 and 3 are block diagrams of exemplary implementations of the present invention.

FIGS. 4 and 5 are exemplary flow diagrams illustrating steps taken to implement various embodiments of the present invention.

### DETAILED DESCRIPTION

INTRODUCTION: A service provider monitors the status of a customer's imaging devices and orders supplies for those devices as required. These supplies include items such as toner and ink required by the imaging devices to function. The supplies are shipped, and, upon receipt, installed by the customer as necessary.

A goal for the service provider is to implement procedures for ensuring that the customer does not run out of supplies such as toner or ink while minimizing the manual intervention required. Another goal is to avoid requiring the customer to maintain an extensive inventory of supplies risking loss or theft. Various embodiments described below operate toward achieving these goals by establishing a timing threshold for use in determining when to issue an alert indicating that the installation of a replacement part is overdue. An overdue installation can indicate that the replacement part has not been delivered or has been lost or mishandled by the customer. Following up an overdue alert can serve to preempt a possible customer service problem. If caught in time, for example, the replacement part can be reordered when such a problem is detected. If appropriate, the customer can be contacted.

The following description is broken into sections. The first section labeled “Environment” describes an exemplary environment in which embodiments of the present invention may be implemented. The second section labeled “Components” describes exemplary physical and/or logical components of various embodiments of the present invention. The third section labeled “Operation” describes exemplary flow charts that illustrate steps taken to implement various embodiments of the present invention.

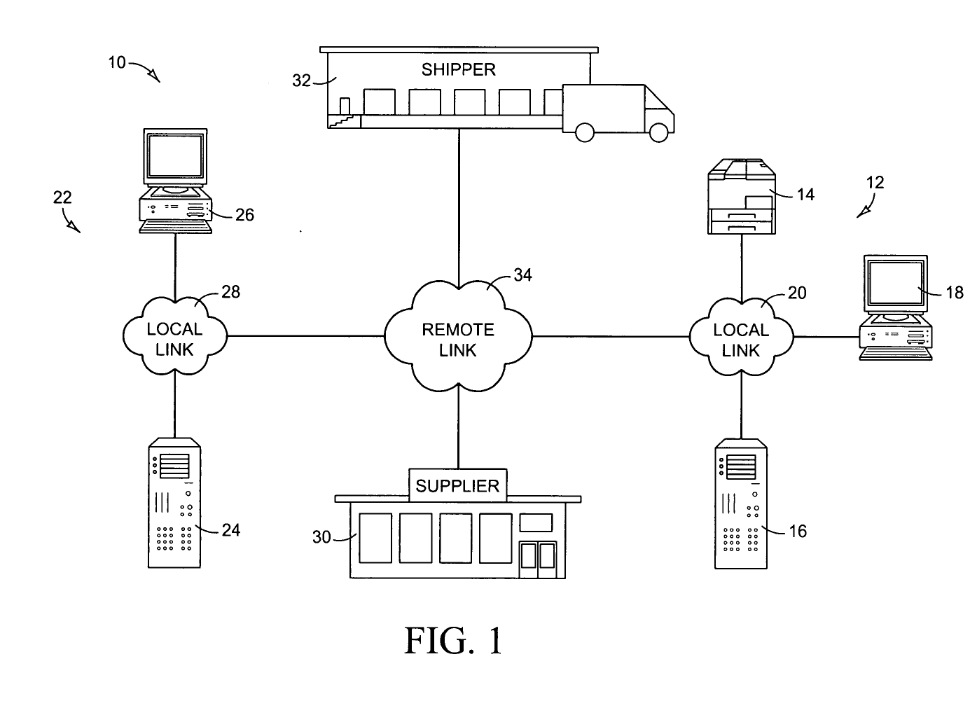

ENVIRONMENT: FIG. 1 illustrates an exemplary environment 10 in which embodiments of the present invention may be implemented. Environment 10 includes customer network 12 which is shown to include imaging device 14, server 16, work station 18, and local link 20. Imaging device 14 represents generally any printer, copier, fax machine or other device capable of printing a desired image on a sheet of paper or other print media. While shown as a single device, imaging device 14 may represent any number of imaging devices of varying types.

Server 16 represents generally any computing device capable of running one or more programs for monitoring the status of imaging device 14. Such programs may be responsible for identifying current toner or ink levels. While shown as a single device, server 16 may represent any number of computing devices of varying types. Work station 18 represents generally any computing device capable of running one or more programs for utilizing imaging device 14. Such programs may include word processors or spreadsheet applications. While shown as a single devices, server 16 and work station 18 may each represent any number of computing devices of varying types.

Local link 20 represents generally one or more cable, wireless, or remote connections via one or more of a telecommunication link, an infrared link, a radio frequency link, and/or any other connector or system that provides electronic communication between devices 14-18. Local link 20 may represent in whole or in part an intranet, the Internet, or a combination of both.

Environment 10 is also shown to include service provider network 22 which includes service manager 24, service work station 26, and local link 28. Service manager 24 represents generally any computing device capable of running one or more programs for identifying a service alert related to imaging device 14. A service alert is any indication that a replacement part such as toner or ink should be ordered. For example, a service alert may indicate that a toner level for imaging device 14 has fallen below a predetermined threshold. If replacement toner is ordered and promptly shipped, it will arrive at the customer's premises before imaging device 14 is depleted of toner. Service manager 24 is also responsible for running programs for ordering replacement parts, monitoring imaging device 14 to determine if a replacement part has been installed, and issuing alerts when installation is overdue.

Service work station 26 represents generally any computing device capable of running one or more programs capable of presenting alerts to a service operator indicating that the installation of a replacement part is overdue. The service operator can then take appropriate corrective action, examples of which are described below.

Local link 28 represents generally one or more cable, wireless, or remote connections via one or more of a telecommunication link, an infrared link, a radio frequency link, and/or any other connector or system that provides electronic communication between devices 24 and 26. Local link 28 may represent in whole or in part an intranet, the Internet, or a combination of both.

Environment 10 is also shown to include supplier 30, shipper 32, and remote link 34. Supplier 30 represents a party responsible for supplying replacement parts for imaging device. Shipper 32 represents a party responsible for delivering replacement parts for imaging device 14. While not shown, supplier 30 has an electronic infrastructure capable of receiving electronic orders from service manager 24. Shipper 32 has an electronic infrastructure capable of sending service manager 24 electronic shipping information related to the shipment of a replacement part for imaging device 14. Such shipping information can include, for example, the delivery status of the replacement part.

Remote link 34 represents generally one or more cable, wireless, or remote connections via one or more of a telecommunication link, an infrared link, a radio frequency link, and/or any other connector or system that provides electronic communication between customer network 12, service provider network 28, supplier 30, and shipper 32. Remote link 34 may represent in whole or in part an intranet, the Internet, or a combination of both.

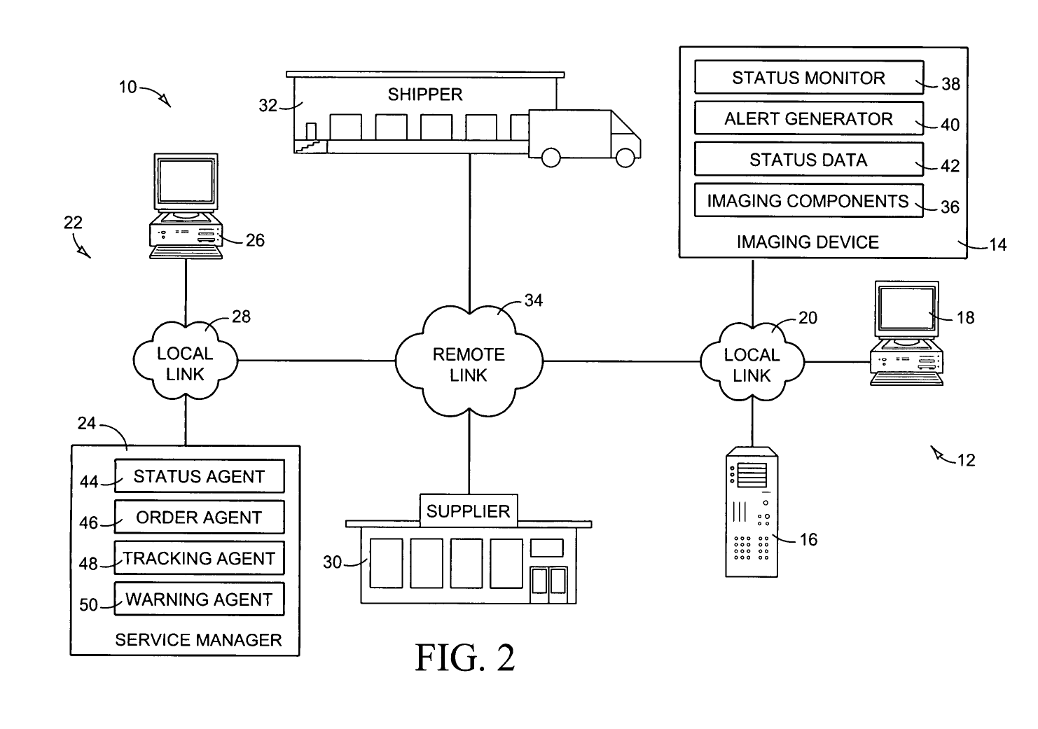

COMPONENTS: FIG. 2 includes exemplary block diagram illustrating physical and logical components operating in customer network 12 and service provider network 22 of environment 10. In the example shown, imaging device 14 includes imaging components 36, status monitor 38, alert generator 40, and status data 42. Imaging components 36 represent the hardware and programming responsible for printing. Imaging components 36 include one or more replaceable parts. For example, where imaging device 14 is a laser printer, imaging components 36 may include a removable toner cartridge. When the toner is depleted through use of imaging device 14, the toner cartridge can be moved, and a replacement toner cartridge can be installed.

Status monitor 38 represents generally any combination of hardware and/or programming capable of monitoring the state of imaging components 36. The state is the current or last known status of imaging components 36. For example, status monitor 38 may monitor toner level where imaging device 14 is a laser printer, or it can monitor ink levels where imaging device 14 is an inkjet printer. Status monitor 38 is also responsible for monitoring the operational status of imaging components 36. Status monitor 38 may track the number of cycles that a replaceable part of imaging components 36 has been used. In other words, status monitor 38 may track the number of pages printed using a particular replaceable part. That part may have a predictable life span, and its replacement can help ensure the proper performance of imaging device 14.

Alert generator 40 represents generally any combination of hardware and/or programming capable of creating a service alert. As noted above, a service alert is any indication that a replacement part such as toner or ink cartridges should be ordered. Creation of a service alert may simply involve storing status data 42 representing the state of imaging components 36. Status data 42 can then be polled by service manager 24 to determine if a predetermined threshold has been passed. A predetermined threshold may, for example, reflect a toner or ink level at which a replacement cartridge is to be ordered. A predetermined threshold may reflect a number of usage cycles for a replaceable part that when surpassed indicates that a replacement part should be ordered. Creation of a service alert may also involve actively sending a service alert to service manager 24.

Service manager 24 is shown to include status agent 44, order agent 46, tracking agent 48, and warning agent 50. Status agent 44 represents any combination of hardware and/or programming capable of monitoring the usage of imaging device 14. In doing so, status agent 44 may periodically poll imaging device 14 to determine statistics such as average number of pages printed per period and the rate of toner or ink consumption. Status agent 44 is also responsible for identifying service alerts for imaging device 14. In doing so, status agent may poll imaging device 14 for status data 42 and examine the status data 42 to determine if a predetermined threshold has been passed. Alternatively, status agent 44 may simply receive a status alert from alert generator 40.

Order agent 46 represents generally any combination of hardware and/or programming capable of sending an electronic order to supplier 30 for a replacement part indicated by a service alert—the order indicating that the replacement part be shipped to a specified customer to be installed in a specified device. Order agent 46 may also be responsible for receiving confirmation from supplier 30 that the order has been received and when it will or has been shipped and, if possible, a tracking number for tracking the shipment.

Tracking agent 48 represents generally any combination of hardware and/or programming capable of detecting when a replacement part has been installed. Tracking agent 48 may perform its task by detecting when a replacement part has been installed. Tracking agent 48 may do this by identifying when a service alert for imaging device 14 has been cleared. For example, a service alert may be created when toner or ink level falls below a threshold. The service alert is cleared when the toner or ink level is raised above the threshold indicating that a replacement toner or ink cartridge has been installed.

Warning agent 50 represents generally any combination of hardware and/or programming capable of determining a timing threshold and issuing an alert indicating that installation of a replacement part is overdue according to the timing threshold. Warning agent 50, for example, may send such alerts to the operator of service workstation 26.

A timing threshold is timing data indicating when to issue an alert that installation of a replacement part is overdue. A timing threshold is selected so that, at a minimum, the replacement part can be reordered and delivered to the customer before the device into which it is to be installed experiences any downtime. In other words, if a service alert indicated that imaging device 14 is predicted to run out of toner or ink on a particular day, a timing threshold may be selected so that an expedited reorder of a toner or ink cartridge will reach the customer on or before that day. A timing threshold may also be selected so that the status of the shipment can be tracked with time enough to determine if the replacement part needs to be reordered. For example, tracking the shipment of the replacement part may reveal that the replacement part was in fact delivered to the customer and a reorder is not necessary. The customer, if appropriate, can be contacted and informed that the replacement part should be installed.

To determine a timing threshold, warning agent 50 maintains and uses a running average (or any other suitable algorithm) of the times between when replacement parts are ordered and when the replacement parts are installed. Warning agent 50 also determines the timing threshold based on device usage monitored by status agent 44. Based on device usage, a critical date for installing a replacement part can be predicted. The critical date for installing a replacement part is the expected date that the part being replaced will no longer function as desired. For instance, it may be the date predicted that imaging device 14 will run out of toner or ink

As an example, the average order to installation time is ten days for a particular customer. Delivery of an expedited reorder will take two days. The timing threshold will be selected so that an alert indicating that installation of a replacement part is overdue will be issued at a point more than ten days after the replacement part is ordered and at least two days before the critical date. It can be said that the timing threshold reflects critical timing information for reordering the replacement part. The timing threshold may reflect critical timing information for tracking a shipment of the replacement part. The phrase critical timing information means information indicating a date and/or time to take a particular action.

Also note that order agent 46 is responsible for timing the ordering of the replacement part based on the average order placement to installation time. In this manner, the replacement part is ordered early enough so that if installation is overdue, the replacement part can be reordered and delivered by the critical date. Consequently, the timing of a service alert may be based on the average order to delivery time and on monitored device usage.

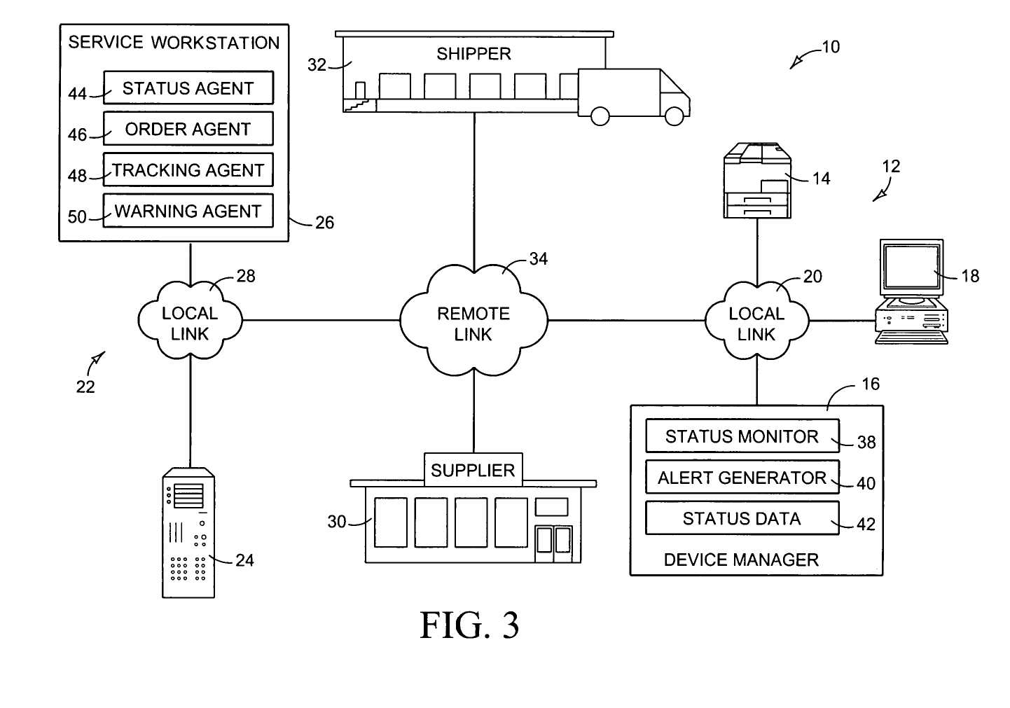

FIG. 3 includes exemplary block diagram illustrating physical and logical components operating in customer network 12 and service provider network 22 of environment 10. In the example of FIG. 3, status monitor 38, alert generator 40, and status data 42 are provided by device manager 16. Alternatively, one or more of status monitor 38, alert generator 40, and status data 42 may be provided by imaging device 14 and the remaining provided by device manager 16. Also in FIG. 3, status agent 44, order agent 46, tracking agent 48, and warning agent 50 are provided by service workstation 26. Alternatively, one or more of status agent 44, order agent 46, tracking agent 48, and warning agent 50 may be provided by service manager 24 and the remaining provided by service workstation 26.

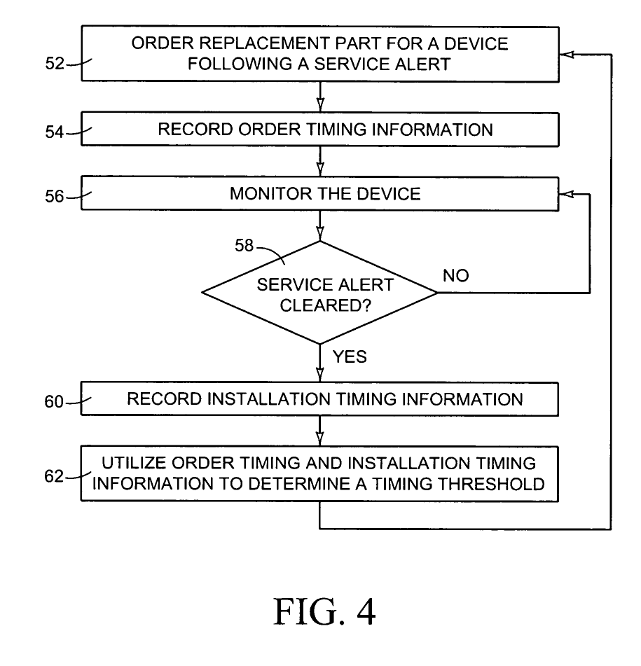

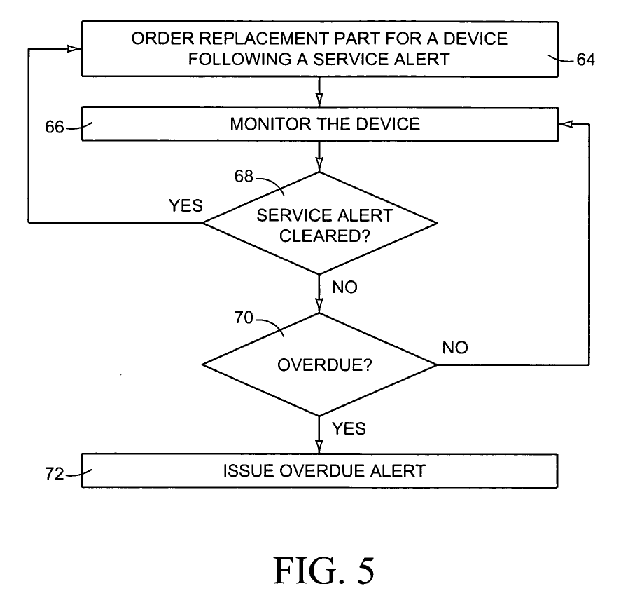

OPERATION: The operation of embodiments of the present invention will now be described with reference to FIGS. 4 and 5. FIG. 4 is an exemplary flow diagram illustrating steps taken to implement an embodiment. Following a service alert, a replacement part is ordered for a device (step 52). Order timing information is stored (step 54). Order timing information is data representing when the order was placed. Referring back to FIGS. 2 and 3, steps 52 and 54 can involve order agent 46 sending an electronic order for a replacement part to supplier 30 and warning agent 50 recording when the replacement part was ordered.

The device is monitored (step 56) to determine if the service alert has been cleared (step 58). The clearing of a service alert indicates that the replacement part has been installed. Installation timing information is then recorded (step 60). Installation timing information is data representing when the replacement part was installed. Referring back to FIGS. 2 and 3, steps 56 and 58 can involve tracking agent 48 identifying that the replacement part has been installed and warning agent 50 recording when the installation occurred.

Upon clearing of the service alert, the order timing information and the installation timing information are utilized to determine a timing threshold for issuing an alert indicating that the installation of the replacement part is overdue (step 62). For example, warning agent 50, using the timing information, can determine the time between when the replacement part was ordered and when it was installed. Where no prior history exists, that time reflects an average order placement to installation time. Where prior history exists, that time can be used to update an existing average order placement to installation time. As described above, the timing threshold is determined at least in part by this average. Device usage information can also play a role.

FIG. 5 is an exemplary flow diagram illustrating steps taken to implement another embodiment. Following a service alert, a replacement part is ordered for a device (step 64). The device is monitored (step 66) to determine if the service alert has been cleared (step 68). The clearing of a service alert indicates that the replacement part has been installed. If it has, the process skips back to step 64. If the service alert has not been cleared, it is determined if the installation is overdue according to a timing threshold (step 70).

As described above, the timing threshold is determined at least in part on an average time between the ordering of replacement parts and the installation of those parts with respect to the particular device. The timing threshold may also be determined according to usage information for the device. Installation can be determined to be overdue in step 70 after the average time Installation has passed but before the critical date. The critical date for installing a replacement part is the date predicted that the part being replaced will no longer function as desired.

If installation is determined not to be overdue, the process skips back to step 66. If determined to be overdue, an overdue alert is issued (step 72). As examples, an overdue alert can be issued for reordering the replacement part and an overdue alert can be issued to track the status of the shipment of the replacement part.

CONCLUSION: The schematic diagram of FIG. 1 illustrates an exemplary environment in which embodiments of the present invention may be implemented. Implementation, however, is not limited to this environment. The block diagrams of FIGS. 2 and 3 show the architecture, functionality, and operation of various embodiments of the present invention. A number of the blocks are defined as programs. Each of those blocks may represent in whole or in part a module, segment, or portion of code that comprises one or more executable instructions to implement the specified logical function(s). Each block may also represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 4 and 5 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for establishing a timing threshold, comprising:
ordering a replacement part according to a service alert for a device;
monitoring the device to determine when the replacement part is installed;
determining a timing threshold based at least in part on a time between when the replacement part was ordered and when the replacement part was installed, the timing threshold being for use in determining when to issue an alert indicating installation of a replacement part is overdue.

2. The method of claim 1, wherein determining comprises determining the timing threshold based at least in part on a historical average of times between when prior replacement parts were ordered and when the prior replacement parts were installed in the device, the historical average being updated according to the time between when the replacement part was ordered and when the replacement part was installed.

3. The method of claim 1, further comprising monitoring device usage and wherein determining comprises determining a timing threshold based at least in part on the device usage and the time between when the replacement part was ordered and when the replacement part was installed.

4. The method of claim 1, wherein the timing threshold at least indirectly identifies critical timing information for reordering the replacement part.

5. The method of claim 1, wherein the timing threshold at least indirectly identifies critical timing information for tracing a shipment of the replacement part.

6. The method of claim 1, further comprising:
ordering a second replacement part according to a second service alert for the device;
monitoring the device to determine whether the second replacement part has been installed; and
issuing an overdue alert according to the timing threshold if the second replacement part has not been installed.

7. The method of claim 6, wherein issuing an overdue alert comprises issuing an overdue alert for reordering the replacement part.

8. The method of claim 6, wherein issuing an overdue alert comprises issuing an overdue alert for tracing a shipment of the replacement part.

9. A method for issuing an overdue alert, comprising:
determining a timing threshold based at least in part on a historical average of times between when prior replacement parts were ordered and when the prior replacement parts were installed in the device;
ordering a current replacement part according to a service alert for the device;
monitoring the device to determine whether the current replacement part has been installed; and
issuing an overdue alert according to the timing threshold if the current replacement part has not been installed.

10. The method of claim 9, wherein issuing an overdue alert comprises issuing an overdue alert for reordering the replacement part.

11. The method of claim 9, wherein issuing an overdue alert comprises issuing an overdue alert for tracing a shipment of the replacement part.

12. A computer readable medium having instructions for:
ordering a replacement part according to a service alert for a device;
monitoring the device to determine when the replacement part is installed;
determining a timing threshold based at least in part on a time between when the replacement part was ordered and when the replacement part was installed, the timing threshold being for use in determining when to issue an alert indicating installation of a replacement part is overdue.

13. The medium of claim 12, wherein the instructions for determining comprises determining the timing threshold based at least in part on a historical average of times between when prior replacement parts were ordered and when the prior replacement parts were installed in the device and updating the historical average according to the time between when the replacement part was ordered and when the replacement part was installed.

14. The medium of claim 12, having further instructions for monitoring device usage and wherein the instructions for determining include instructions for determining a timing threshold based at least in part on the device usage and the time between when the replacement part was ordered and when the replacement part was installed.

15. The medium of claim 12, wherein the timing threshold at least indirectly identifies critical timing information for reordering the replacement part.

16. The medium of claim 12, wherein the timing threshold at least indirectly identifies critical timing information for tracing a shipment of the replacement part.

17. The medium of claim 12, having further instructions for:
ordering a second replacement part according to a second service alert for the device;
monitoring the device to determine whether the second replacement part has been installed; and
issuing an overdue alert according to the timing threshold if the second replacement part has not been installed.

18. The medium of claim 17, wherein the instructions for issuing an overdue alert include instructions for issuing an overdue alert for reordering the replacement part.

19. The medium of claim 17, wherein the instructions for issuing an overdue alert include instructions for issuing an overdue alert for tracing a shipment of the replacement part.

20. A computer readable medium having instructions for:
determining a timing threshold based at least in part on a historical average of times between when prior replacement parts were ordered and when the prior replacement parts were installed in the device;
ordering a current replacement part according to a service alert for the device;
monitoring the device to determine whether the current replacement part has been installed; and
issuing an overdue alert according to the timing threshold if the current replacement part has not been installed.

21. The medium of claim 20, wherein the instructions for issuing an overdue alert include instructions for issuing an overdue alert for reordering the replacement part.

22. The medium of claim 20, wherein the instructions for issuing an overdue alert include instructions for issuing an overdue alert for tracing a shipment of the replacement part.

23. A system for establishing a timing threshold, comprising:
an ordering agent operable to order a replacement part according to a service alert for a device;
a tracking agent operable to monitor the device to determine when the replacement part is installed; and
a warning agent operable to determine a timing threshold based at least in part on a time between when the replacement part was ordered and when the replacement part was installed, the timing threshold being for use in determining when to issue an alert indicating installation of a replacement part is overdue.

24. The system of claim 23, wherein the warning agent is operable to determine the timing threshold based at least in part on a historical average of times between when prior replacement parts were ordered and when the prior replacement parts were installed in the device and to update the historical average according to the time between when the replacement part was ordered and when the replacement part was installed.

25. The system of claim 23, further comprising a status agent operable to monitor device usage and wherein the warning agent is operable to determine the timing threshold based at least in part on the device usage and the time between when the replacement part was ordered and when the replacement part was installed.

26. The system of claim 23, wherein the timing threshold at least indirectly identifies critical timing information for reordering the replacement part.

27. The system of claim 23, wherein the timing threshold at least indirectly identifies critical timing information for tracing a shipment of the replacement part.

28. The system of claim 23, wherein:
the ordering agent is operable to order a second replacement part according to a second service alert for the device;
the tracking agent is operable to monitor the device to determine whether the second replacement part has been installed; and
the warning module is operable to issue an overdue alert according to the timing threshold if the second replacement part has not been installed.

29. The system of claim 28 wherein the warning agent is operable to issue an overdue alert for reordering the replacement part.

30. The system of claim 28, wherein the warning agent is operable to issue an overdue alert for tracing a shipment of the replacement part.

31. A system for issuing an overdue alert, comprising:
a warning agent operable to determine a timing threshold based at least in part on a historical average of times between when prior replacement parts were ordered and when the prior replacement parts were installed in the device;
an ordering agent operable to order a current replacement part according to a service alert for the device; and
a tracking agent operable to monitor the device to determine whether the current replacement part has been installed; and
wherein the warning agent is operable to issue an overdue alert according to the timing threshold if the current replacement part has not been installed.

32. The system of claim 31, wherein the warning agent is operable to issue an overdue alert for reordering the replacement part.

33. The system of claim 31, wherein the warning agent is operable to issue an overdue alert for tracing a shipment of the replacement part.

34. A system for calculating a timing threshold, comprising:
a means for ordering a replacement part according to a service alert for a device;
a means for monitoring the device to determine when the replacement part is installed; and
a means for determining a timing threshold based at least in part on a time between when the replacement part was ordered and when the replacement part was installed, the timing threshold being for use in determining when to issue an alert indicating installation of a replacement part is overdue.

35. A system for issuing an overdue alert, comprising:
a means for determining a timing threshold based at least in part on a historical average of times between when prior replacement parts were ordered and when the prior replacement parts were installed in the device;
a means for ordering a current replacement part according to a service alert for the device; and
a means for monitoring the device to determine whether the current replacement part has been installed; and
a means for issuing an overdue alert according to the timing threshold if the current replacement part has not been installed.
